(19) United States
(12) Patent Application Publication
(10) Pub. No.: US 2004/0031391 A1
(43) Pub. Date: Feb. 19, 2004

(54) Device for separating air from a waste water mixture, especially for a medical or dental medical treatment facility

(76) Inventors: Michael Grimm, Munderkingen (DE); Baur Helmut, Unteresendorf (DE); Braetsch Hartmut, Assmannshardt (DE)

Correspondence Address: James P Zeller, Marshall Gerstein & Borun, Sears Tower Suite 6300, 233 South Wacker Drive, Chicago, IL, 60606-6357, US

(21) Appl. No.: 10/343,134

(22) PCT Filed: Aug. 2, 2001
(86) PCT No.: PCT/EP01/08939

(30) Foreign Application Priority Data
Aug. 7, 2000 (DE) 100 38 422.6

(51) Int. Cl. B01D 19/00

(52) U.S. Cl. 96/209; 96/214; 96/217

(57) ABSTRACT

The invention relates to a device (1) for the separation of air out of a waste water mixture, in particular such a waste water mixture as arises at a medical or dental-medical treatment station, having a housing (2) which has a round cross-sectional form in horizontal cross-section, an inlet (3) for the waste water mixture which tangentially opens into the housing (2), a first outlet (4) for air, arranged above the inlet (3), and a second outlet (5) for heavy materials, such as waste water, arranged below the inlet (3). For the purpose of improving the separation function, the inlet (3) is arranged in the region of a hollow cone shaped peripheral wall section (6) of the housing (2), which section is downwardly divergent.

The invention relates to a device in accordance with the preamble of claim 1.

At a medical or dental-medical treatment station when treatment of a human or animal body takes place there arise treatment residues, such as e.g. rinsing and/or cooling fluid, e.g. water, body fluid, e.g. pus and/or blood, and residues of working involving material removal, which are drawn off from the treatment site by means of a suction line. If, in the working, metals are worked, as is often the case with a medical or dental-medical treatment or operation, there arise as residues also metal particles or chips, e.g. gold or amalgam, which are likewise drawn off with the suction line. For functional reasons and for reasons of environmental protection there is needed a separation of the components of the waste water mixture before it is passed into the public sewerage system.

The separation of the components of the waste water mixture can be effected in common separation device or in stages in a plurality of separation devices connected one after another.

In DE 43 38 718 C2 there is described a separation unit for dental purposes, having a housing which has an inlet connection for the waste water mixture to be separated out and a first outlet connection for air and also a second outlet connection for liquid and solid mixture components. The inlet connection is located on the underside of the housing in central position. The first outlet connection for air is on the upper side of the housing in central position. The second outlet connection for liquid and solid mixture components is located in a tangential side position. With this known separation unit the delivery line for the waste water mixture extending to the separation unit is directed upwardly. In the case of flexible sections of the suction line, e.g. in the region of a suction hose adjoining a suction cannula, the upwardly directed extension is less problematic, because due to the movement of the suction hose solid particles are carried along by the flow and thereby deposits and flow problems caused thereby are avoided. Directly before the separation device, however, a delivery line is as a rule not flexible and is fixedly installed. There are thus needed considerable flow velocities in order to avoid that solid and heavy particles of the waste water mixture are deposited at more deeply lying positions of the delivery line.

A device of the kind indicated in the introduction is described in DE 39 16 742 C3. With this known device there is involved a separation unit for the separation of air and solid particles, in particular fine particles of amalgam, from the waste water arising at a dental work station. With this known separation unit, a delivery line for the waste water mixture opens to the side and tangentially into a hollow cylindrical housing in which due to the centrifugal effect the air component is separated out and leaves the housing upwardly through a central and coaxially arranged air discharge connection. Below the inlet for the waste water mixture there is located on the housing a liquid outlet in side tangential position. A further outlet for solid components is located beneath the liquid outlet.

With a device of the kind indicated in the introduction, the flow in the device is generated through the suction air flow which is maintained by means of a suction device connected with the outlet for the air. The separated air should thus be as “dry” as possible, in order to avoid the introduction of liquid parts into the suction device. Further, the device of the kind indicated in the introduction should have a construction which is as compact as possible in order to be able to arrange it in the region of the treatment station without difficulty.

The object of the invention is thus, with a device of the kind indicated in the introduction, to improve the separation function whilst ensuring a simple and compact construction.

This object is achieved by means of the features of claim 1. Advantageous developments of the invention are indicated in the subclaims.

With the device in accordance with the invention, the inlet for the waste water mixture is arranged in the region of a hollow cone shaped peripheral wall section of the housing, which is formed downwardly divergently. Through this, the separation of the air from the remaining heavier components is promoted because the divergent arrangement of the inner surface of the peripheral wall section generates for the heavier materials a downwardly directed force component which acts additionally to gravity. Through this the separation or screening function is substantially improved. The device in accordance with the invention thus distinguishes itself through a high separation performance or screening performance, whereby also the quality of the separation is improved, which is manifest through a higher degree of dryness of the separated air.

The subclaims contain features which improve and activate the functioning and effectiveness of the device, and lead to a more compact and economically producible construction, which is long lived and not susceptible to faults.

Below, the invention and further advantages which can be achieved thereby will be described in more detail with reference to advantageous configurations of exemplary embodiments and to simplified drawings. There is shown

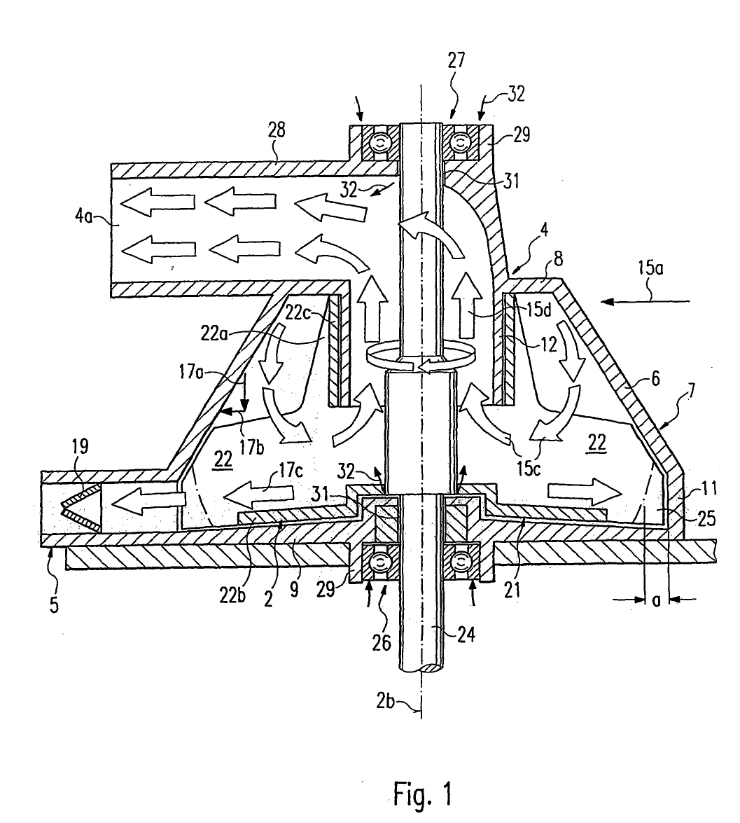

FIG. 1 a device in accordance with the invention for the separation or screening of air or gas out of a waste water mixture, in vertical section;

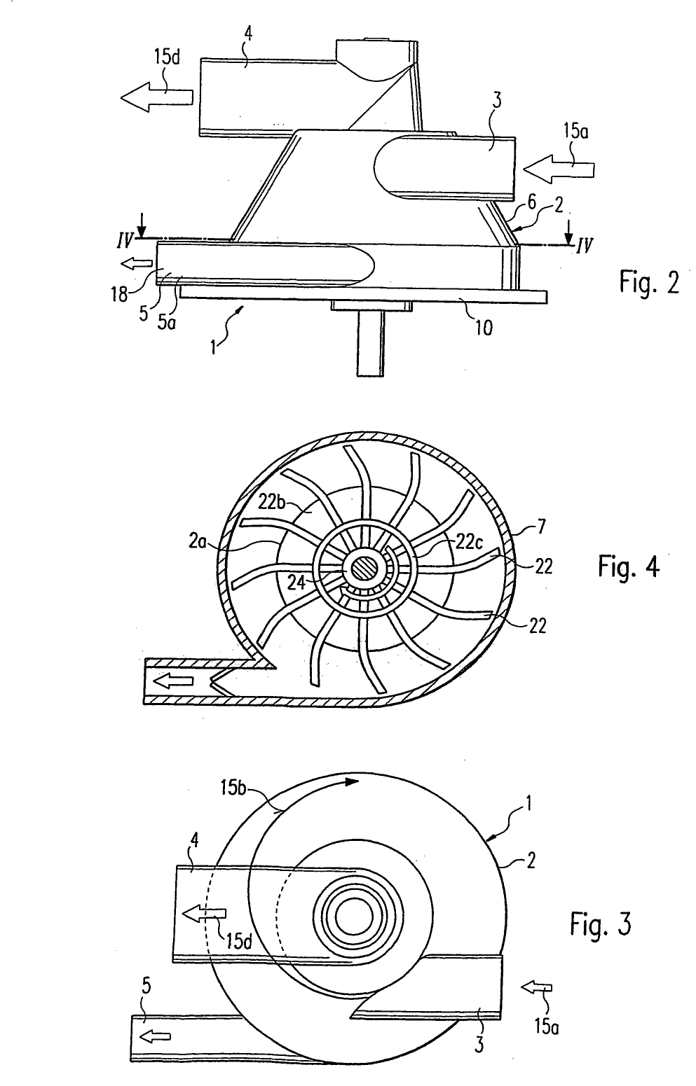

FIG. 2 the device in an external view;

FIG. 3 the device in a view from above;

FIG. 4 the section IV-IV in FIG. 2;

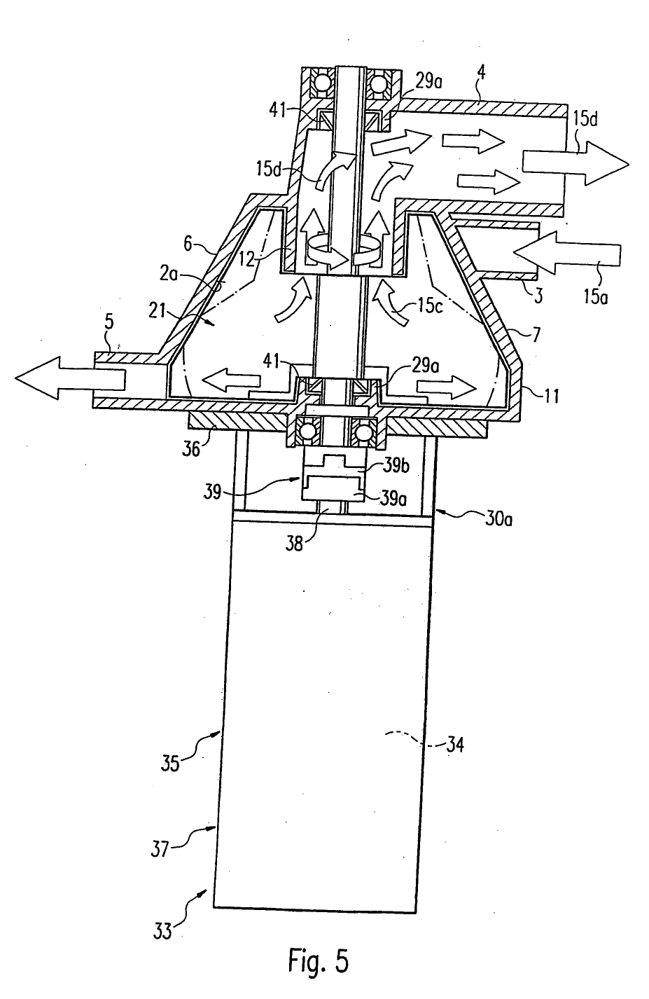

FIG. 5 the device according to FIG. 1 in a modified configuration and as a unit assembly;

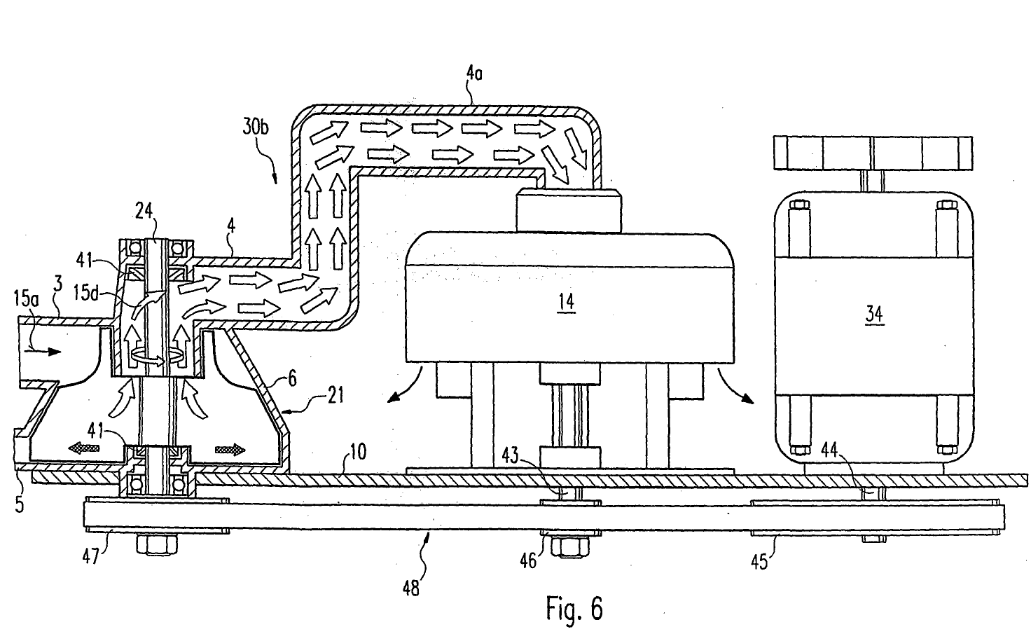

FIG. 6 the device according to FIG. 5 as a modified unit assembly;

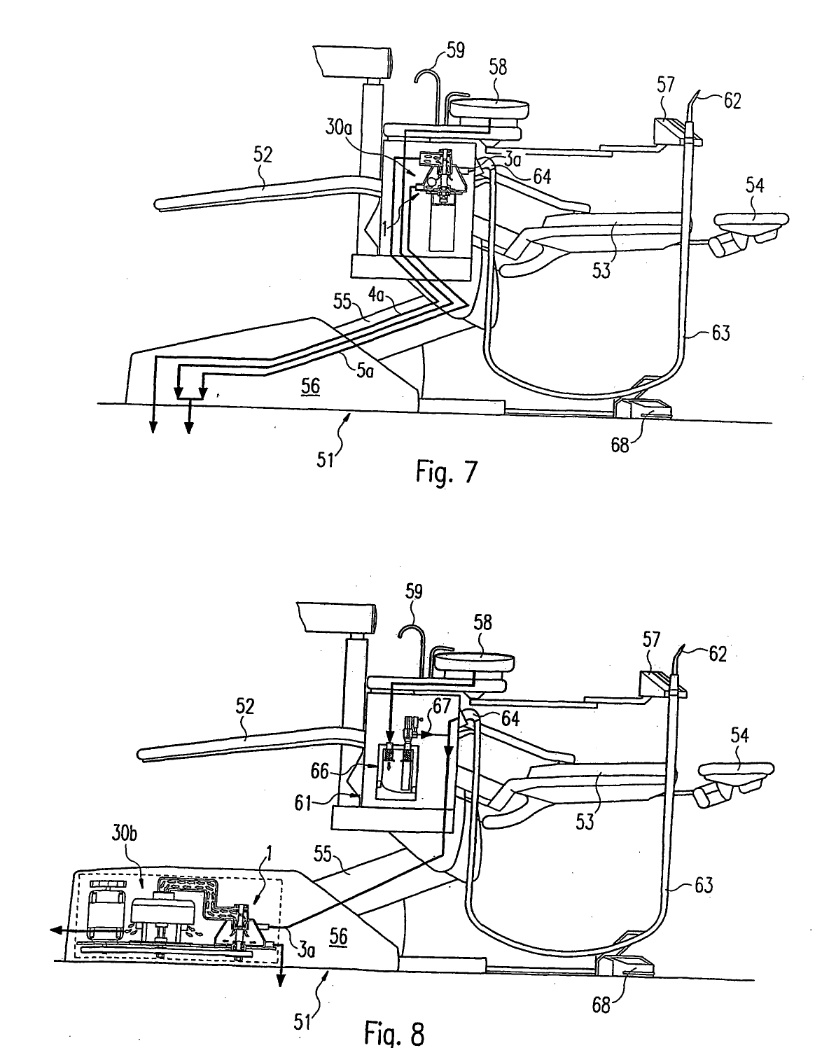

FIG. 7 an example of an arrangement for the device at a treatment chair;

FIG. 8 a modified example of an arrangement for the device at a treatment chair.

The device, designated in its entirety by 1, has a housing 2 with an inlet 3 for a waste water mixture, in particular for a waste water mixture that arises at a medical or dental-medical treatment station, and two outlets, of which one is an outlet 4 for air and the other is an outlet 5 for heavy materials or contaminated water, which each may be formed by means of a pipe socket which defines an opening, the pipe socket of the outlet 5 extending tangentially or secantially of the housing 2.

The inlet 3 is, with reference to a downwardly divergent hollow cone shaped peripheral wall section 6 of an upright peripheral wall 7 of the housing, arranged tangentially and preferably in the upper end region of the hollow cone shaped peripheral wall section 6. At the upper end of the cone shaped section 6 there may adjoin a horizontal cover wall 8, through which the housing 2 attains at its upper end a substantially truncated cone shape. On the underside, the truncated cone shaped section 6 may be closed directly by means of a floor wall 9 or there may be arranged between the hollow cone shaped section 6 and the floor wall 9 a substantially hollow cylindrical section 11.

The first outlet 4 for air extends upwardly in a central position, whereby outside the housing 2 it may be curved or angled by about 90°. Preferably the first outlet 4 extends from an inner, in particular hollow cylindrical, pipe socket 12 which reaches approximately as far as the middle region of the housing 2 and in the present exemplary embodiment reaches as far as the middle region or lower region of the hollow cone shaped section 6. The interior of the housing 2, designated by 2a, is rotationally symmetrically formed with reference to its vertical middle axis 2b. The second outlet 5 borders on the inner surface of the floor wall 9, which is flat or preferably radially somewhat inclined, whereby it is conically shaped in the sense of a truncated cone. 10 designates a carrier plate which may be attached to the floor wall 9.

The functioning of the device 1 is as follows. With a suction machine, connected to the first outlet 4 for air, illustrated only in FIGS. 5 and 7, there is generated in the housing a suction air flow indicated by means of flow arrows, which as input flow 15a flows into the housing interior 2a tangentially with regard to the hollow conical shaped peripheral wall 6 and generates therein a circular flow 15b directed clockwise, in the view from above according to FIG. 3, from which there branches off a separating flow 15c directed downwardly and at the same time spiral-shaped inwardly, and simultaneously directed upwardly to the opening of the pipe socket 12 and in the pipe socket 12, which in the region of the first outlet 4 for air or in the connection line 4a leading to the suction machine 14 changes to a laminar outlet flow 15d. In the region of the circular flow 15b and in the region of the separating flow 15c the air is separated from the waste water, which occurs due to the effectiveness of two force components, namely on the one hand due to the gravitational force indicated by vertical arrows 17a and the centrifugal force indicated by horizontal arrows 17b. The components of the waste water which are heavier than air, here water and solid particles resulting from the medical or dental-medical treatment, fall in the region of the circular flow 15b and the separating flow 15c into the lower region of the housing 2 where, due to the circular flow 15b and the thereby effective centrifugal force 17c, they reach outwardly to the peripheral wall 7, where they flow out of the tangential second outlet 5 for contaminated water. The second outlet 5 can be connected by means of a connection line 5a with the waste water line present, which will be explained in more detail with reference to FIGS. 7 and 8. In the connection line 5a or in the region of the second outlet 5 there is preferably arranged a blocking valve 19, formed by means of non-return valve, e.g. a spear valve, which prevents a backflow out of the connection line 5a or the waste water line 18 into the housing interior 2a. Through this the housing interior 2a is, inter alia, protected from microbic contamination.

For the purpose of promoting the centrifugal force 17c effective in particular in the lower region of the housing interior 2a it is advantageous to promote or strengthen the circular flow 15b by means of a rotor 21 and thereby likewise to support or strengthen the outlet flow 15d. For this purpose there is suited a rotor 21, e.g. a propeller, of such type that through its rotation the parts of the waste water mixture which are heavier than air are forced outwardly and which at the same time supports or promotes the circular flow 15b. With the present exemplary embodiment a propeller is provided with axially and radially arranged propeller blades 22 which are located in the lower region of the housing interior 2a and transport the heavy parts to the peripheral wall 7 and to the second outlet 5. In radial direction, the propeller blades 22 may extend up to the peripheral wall 7 or have a spacing a from the hollow conical shaped peripheral wall section 6 and/or from the hollow cylindrical peripheral wall section 11, so that at least in the radial region of the opening of the second outlet 5 there arises a free annular space 23 between the propeller blades 22 and the peripheral wall 7, in which the circular flow 15b can take place independently of the propeller blades. In the axial direction, the propeller blades 22 can extend from the floor wall 9 e.g. up to the hollow conical shaped peripheral wall 6 or into its lower region, as is shown in FIG. 1. It has also shown itself to be advantageous to provide in the inner region of the section of the housing interior 2a surrounding the pipe socket 12 rotating propeller blades, which are advantageously sections of the propeller blades 22 and may be formed by thin upwardly extending propeller strips 22a which may taper upwardly in a wedge shape. The propeller blades 22 may be fixed to a vertical rotor shaft 24. For stabilization of the propeller blades 22 their lower edges may be attached to a round disc 22b which has a small movement spacing from the floor wall 9. The propeller strips 22a may be stabilised by means of stiffening sleeve 22c to which the inner edges of the propeller strips 22a are attached and which surrounds the pipe socket 12 with a small radial movement spacing.

The propeller strips 22a can contribute the strengthening the centrifugal force components in the free annular space surrounding them.

The rotation shaft 24 is rotatably mounted in the region of the floor wall 9 and the covering wall 8 in each case in a roller bearing 26, 27. If the connection line 4a develops angled to the side directly above the cover wall 8, the upper roller bearing 27 may be arranged on the upper wall section 28 of the connection line 4a. Preferably the roller bearings 26, 27 are applied externally on the wall 9, 28 concerned and placed in bearing bushes 29 projecting from the wall 9, 28, whereby in the floor wall 9 and in the wall section 28 in each case there is arranged a through hole 31 through which the rotation shaft 24 extends with play for movement.

One or both roller bearing 26, 27 are, in the exemplary embodiment according to FIG. 1, intentionally not sealed off, whereby at least one seal can be saved. This configuration is based on the insight that due to the partial vacuum arising in functional operation, there is a partial vacuum not only in the upper region of the housing 2 or the connection line 4a, but a partial vacuum is also present in the lower region of the housing 2 which prevents an exit of liquid or gas through the seams of the roller bearings 26, 27. This is made clear in FIG. 1 by means of flow arrows 32. Due to the normal play for movement between the components concerned, in particular between the roller bearings 26, 27 on the one hand and the floor wall 9 or the wall section 28 on the other hand, there arise flow gaps which in the region of the bearing gaps ensure the air entry flow and air flow around the bearings. If, due to the play for movement present, the respective bearing gaps might be temporally closed, e.g. through close bearing of the bearing parts concerned on one another, in particular between the roller bearing inner ring and the floor wall 9 or the wall section 28, this is not damaging since a closure of the bearing gap with regard to the exit of gas and liquid is of no consequence.

As FIG. 4 in particular shows, the end regions of the propeller blades 22 may be angled or curved away counter to the rotation direction (see circular flow 15b), whereby the effectiveness in applying to the heavy materials a radially outwardly directed accelerating force is improved.

The rotation shaft 24 or the rotor 21 is rotatable by means of a preferably electrical rotary drive 33, which in the exemplary embodiment according to FIG. 5 has a drive motor 34 in a drive housing 35 having an upper carrier flange 36 on which the housing 2 is arranged and attached, e.g. bolted, and forms a carrier stand 37 for the device 1 or the housing 2. Between the upper end of a vertical motor shaft 38 and the rotor shaft 24 there is arranged an elastic claw coupling 39 having claws 39a towards one another, between which there sits a coupling element 39b of elastic material, in particular rubber or plastics, and form-fittingly engages in the claws 39a.

Further, FIG. 5 shows shaft seals for the rotation shaft 24, which may be constituted by sealing rings 41, which are mounted on inner bearing bushes 29a on the floor wall 9 or on the wall section 28. As FIG. 5 for example shows, the propeller blades 22 may extend axially as far as the upper region of the interior 2a. This structural unit is designated by 30a.

The horizontal direction of extension of the outlets 4, 5 or their connection lines 4a, 5a and the horizontal direction of extension of the inlets 3 or its connection line 3a can be formed differently and adapted to the requirements of the installation conditions, as FIGS. 1 and 2 already show, which for example show directions of extension for the connection line 4a which are opposite to one another.

With the exemplary embodiment in accordance with FIG. 6, in which the same or similar parts are provided with the same reference signs, the device 1, a suction machine 14 and the drive motor 34 are arranged next to one another on a common carrier plate 10, whereby the associated three rotation shafts 24, 43, 44 pass through the carrier plate 42 each in a through hole and beneath the carrier plate 42 carry drive elements, here belt discs 45, 46, 47, which are part of a drive connection, here of a belt drive 48. This structural unit is designated by 30b.

FIGS. 7 and 8, in which the same or similar parts are likewise provided with the same reference signs, each show a treatment station with a medical or dental-medical treatment chair 51 having a seat part 52 a backrest 53 and a head support 54, which are positionably and height adjustably mounted on a carrier part 55, e.g. a vertically pivotably carrier arm. The carrier part 55 is supported on a base 56, which stands with a stand surface on the floor present. There belong to the treatment chair 51 also a preferably horizontal pivotable instrument repository 57, a spittoon 58 and a water tap 59 for the filling of a non-illustrated rinsing beaker, which are preferably carried by a box housing 61 which may be held or supported on the base 56 or on the carrier part 55. There belongs also to the treatment chair 51 a suction cannula 62 which can be deposited at the instrument repository 57 and is arranged at the free end of a suction hose 63 which is connected with the device 1 and with the present exemplary embodiment is connected to the box housing 61 with a connecting socket 64.

With the exemplary embodiment according to FIG. 7, the device 1 is preferably arranged in the form of a structural unit 30a according to FIG. 5 in the box housing 61.

With the exemplary embodiment according to FIG. 8, the device 1 is preferably arranged in the form of a structural unit 30b in the base 56. In both of the above-mentioned arrangements, the connection lines 4a, 5a extend in accordance with FIG. 7 or a connection line 3a connecting the connection socket 64 with the inlet 3a extends preferably through the carrier part 55 into the base 56, from where in the exemplary embodiment according to FIG. 7 the connection line 4a is connected with a non-illustrated suction machine. The connection line 5a may be connected with the waste water line 65 present.

As can be understood from FIG. 8, there may be arranged in the box housing 61 an intermediate container 66 for waste water delivered from the spittoon 58, the outlet of which container is connected through a connection line 67 with the connection line 3a.

There is further associated with the treatment chair 51 a foot switch 68 at which known functions of the treatment chair 51 can be switched on and switched off, such as for example a switching on and switching off of the device 1.

With all exemplary embodiments there may be arranged before the device 1, integrated therein or arranged thereafter, e.g. in the connection line 3a, or in the connection line 5a, a device for the separation or screening of particularly heavy materials, such as heavy metals, in particular amalgam.

1. Device (1) for the separation of air out of a waste water mixture, in particular such a waste water mixture as arises at a medical or dental-medical treatment station, having
a housing (2) which has a round cross-sectional form in horizontal cross-section,
an inlet (3) for the waste water mixture which tangentially opens into the housing (2),
a first outlet (4) for air, arranged above the inlet (3), and
a second outlet (5) for heavy materials, such as waste water, arranged below the inlet (3),
characterised in that,
the inlet (3) is arranged in the region of a hollow cone shaped peripheral wall section (6) of the housing (2), which section is downwardly divergent.

2. Device according to claim 1,
characterised in that,
the inlet (3) is arranged in the upper end region of the divergent peripheral wall section (6).

3. Device according to claim 1 or 2,
characterised in that,
to the hollow cone shaped peripheral wall section (6) there adjoins below a substantially hollow cylindrical peripheral wall section (11).

4. Device according to any preceding claim,
characterised in that,
the second outlet (5), for heavy materials, is arranged in the lower end region of the peripheral wall (7) of the housing (2) and is tangentially directed.

5. Device according to any preceding claim,
characterised in that,
the first outlet (4), for air, opens out upwardly out of the housing (2) in coaxial position.

6. Device according to claim 5,
characterised in that,
the first outlet (4) for air has a pipe socket (12) which extends downwardly into the housing interior (2a) preferably as far as the middle height region of the housing (2) or of the hollow cone shaped peripheral wall section (6).

7. Device according to any preceding claim,
characterised in that,
at least in the lower region of the interior (2a) of the housing (2) there is arranged a rotor (21) which urges the heavy materials radially outwardly.

8. Device according to claim 7,
characterised in that,
the rotor (21) has propeller blades (22) which extend in substance radially and axially.

9. Device according to claim 8,
characterised in that,
the propeller blades (22) extend in radial direction up to the peripheral wall (7) or have a spacing (a) from the hollow cone shaped peripheral wall section (6) and/or from the hollow cylindrical peripheral wall section (11), which spacing provides for an annular space (23).

10. Device according to claim 8 or 9,
characterised in that,
the propeller blades (22) extend in axial direction up to the middle region of the housing (2) and/or into the upper region of the hollow cone shaped peripheral wall section (6) and, if applicable, extend with radially tapered propeller strips (22a) into the upper region of the housing (2).

11. Device according to any preceding claim,
characterised in that,
in the region of the second outlet (5) for heavy materials, or in a connection line (5a) adjoining thereto, there is arranged a blocking valve (19), in particular a non-return valve, which self-actingly opens in the outlet direction and blocks in the inlet opening.

12. Device according to any of claims 5 to 11,
characterised in that,
the first outlet (4), for air, is angled or curved by about 90° with a side or radial outlet opening.
